(19) United States
(12) Patent Application Publication
(10) Pub. No.: US 2026/0326700 A1
(43) Pub. Date: Oct. 22, 2026

(54) SMART VEHICLE SYSTEMS AND CONTROL LOGIC FOR QUANTIFYING AND LOCATING OCCUPANTS USING INTERIOR AMBIENT LIGHTING

(71) Applicant: GM GLOBAL TECHNOLOGY OPERATIONS LLC, Detroit, MI (US)

(72) Inventors: Dakota Rosell, Wolverine Lake, MI (US); Joel B. Thompson, Sterling Heights, MI (US); Joseph Mitchell, Troy, MI (US)

(73) Assignee: GM GLOBAL TECHNOLOGY OPERATIONS LLC, Detroit, MI (US)

(21) Appl. No.: 19/184,075

(22) Filed: Apr. 21, 2025

(51) Int. Cl. B60R 21/015; B60N 2/00; B60N 2/26; B60Q 3/233; B60Q 3/74; B60Q 3/85; B60R 21/0132

(52) U.S. Cl. CPC B60R 21/01534; B60N 2/0024; B60N 2/267; B60N 2/271; B60Q 3/233; B60Q 3/74; B60Q 3/85; B60R 21/0132; B60R 21/01516

(57) ABSTRACT

Presented are smart vehicle systems for quantifying and locating occupants using interior ambient lighting, methods for making/using such systems, and vehicles equipped with such systems. A method of operating a motor vehicle includes a vehicle controller communicating with multiple in-cabin seat sensors to receive therefrom seat sensor data identifying which vehicle seats are occupied. The vehicle controller also receives an alert from a vehicle dynamics sensor indicating a vehicle trigger event was detected; in response, the controller retrieves an interior ambient lighting (IAL) map for an IAL system with numerous multicolor lamp units located inside the passenger cabin. The IAL map associates each multicolor lamp unit with a respective one of the occupied vehicle seats. Using the IAL map, the vehicle controller commands each multicolor lamp unit associated with an occupied vehicle seat to output a predefined color in a predefined pattern to denote a characteristic of that vehicle seat.

### INTRODUCTION

The present disclosure relates generally to systems and methods for monitoring vehicle occupants. More specifically, aspects of this disclosure relate to networked arrays of in-cabin sensors for quantifying and locating occupants after a vehicle trigger event.

Current production motor vehicles, such as the modern-day automobile, may be originally equipped with a network of resident controllers, sensors, and communications devices that enable a variety of vehicle services, such as advanced driver assistance system (ADAS) operations and automated passenger protection procedures. For instance, many passenger vehicles utilize a network of occupant seat sensors, typically in the form of seat-cushion mounted pressure sensors, to actively detect the presence of a passenger in each of the vehicle's passenger seats. Along with monitoring seat occupancy, seat sensors may also be used to detect occupant weight, e.g., to differentiate between children and adults, and occupant position, e.g., to derive occupant location relative to the steering wheel or dashboard. These occupant seat sensors are used primarily to regulate operation of the vehicle's supplemental inflatable restraint (SIR) system, including the selective deactivation of passenger airbags and the active modulation of airbag deployment forces. In addition to passenger protection, seat sensors may be used to adjust seat settings for enhanced comfort, to generate seatbelt reminders for vehicle passengers, and to automate rear seat alerts for reminding drivers to check the back seat when alighting the vehicle.

### SUMMARY

Presented herein are smart vehicle systems with attendant control logic for quantifying and locating occupants using interior ambient lighting, methods for manufacturing and methods for operating such systems, and motor vehicles equipped with such systems. By way of example, and not limitation, a passenger vehicle contains a distributed network of seat sensors and seatbelt sensors for actively monitoring which of the vehicle passenger seats are occupied and which of the vehicle seatbelts are properly latched. Located inside the vehicle passenger cabin is an interior ambient lighting (IAL) system with an independently operable, multicolor lamp unit packaged adjacent each of the in-cabin seating positions. If a vehicle trigger event is detected, the interior ambient lighting system leverages the occupant sensor network to actively generate predefined visual cues designed to provide real-time information to aiding parties. To alert first responders to the number and location of vehicle occupants, for example, the lighting system may activate a select subset of the lamp units in a predefined color (e.g., amber) and a predefined pattern (e.g., slow flashing) to draw attention to each seat where an occupant was detected prior to the impact event. If the passenger of an occupied seat was not wearing their seatbelt, the lamp unit for that seat may be activated to generate a different color (e.g., red) in a different pattern (e.g., fast flashing). Non-location-specific lamps, such as roof-mounted ambient lighting, may be set to steady, full-intensity white to increase visibility in the passenger cabin. These features help to increase occupant protection especially for passengers that are incapacitated or visibility inside the cabin is obstructed.

Aspects of this disclosure are directed to interior ambient lighting systems and lighting system control logic for quantifying and locating occupants of a vehicle passenger cabin. In an example, a method is presented for operating a motor vehicle with a passenger cabin containing multiple vehicle seats. This representative method includes, in any order and in any combination with any of the above and below disclosed options and features: receiving, e.g., via a resident or remote microprocessor, central controller, control module, programmable logic device, integrated circuit (IC) device, or network of processors/ controllers/modules/devices (collectively “vehicle controller”) from a networked array of in-cabin seat sensors, seat sensor data identifying which of the vehicle seats, if any, are occupied; receiving, e.g., via the vehicle controller from one or more vehicle dynamics sensors, dynamics sensor data alerting to detection of a vehicle trigger event (e.g., front impact); retrieving, e.g., via the vehicle controller from a resident or remote memory device responsive to detection of the vehicle trigger event, an IAL map for an IAL system with a network of independently operable, multicolor lamp units located inside the passenger cabin, the IAL map associating each multicolor lamp unit with a respective one of the vehicle seats; and commanding, e.g., via the vehicle controller using the IAL map, each multicolor lamp units associated with one of the occupied vehicle seats to output a vehicle-calibrated visual cue in the form of a preset color in a preset pattern designed to denote a characteristic of the occupied vehicle seat (e.g., seat occupied with latched seatbelt).

Aspects of this disclosure are also directed to computer-readable media (CRM) containing controller-executable instructions for quantifying and locating occupants of a vehicle passenger cabin. In an example, a non-transient CRM stores instructions that are executable by a vehicle controller of a motor vehicle with a passenger cabin containing multiple vehicle seats. These CRM-stored instructions, when executed, cause the vehicle controller to perform operations that include: receiving, from multiple seat sensors located inside the passenger cabin, seat sensor data identifying the vehicle seats that are occupied; receiving, from a vehicle dynamics sensor, dynamics sensor data indicating detection of a vehicle trigger event; retrieving, responsive to detection of the vehicle trigger event, an interior ambient lighting map for an IAL system with multiple multicolor lamp units located inside the passenger cabin, the IAL map associating each of the multicolor lamp units with a respective one of the occupied vehicle seats; and commanding the multicolor lamp units associated with the occupied vehicle seats to output a first preset color in a first preset pattern configured to denote a characteristic of the occupied vehicle seat.

Additional aspects of this disclosure are directed to motor vehicles equipped with interior ambient lighting systems and occupant monitoring systems for quantifying and locating occupants of the vehicle's passenger cabin. As used herein, the terms “vehicle” and “motor vehicle” may be used interchangeably and synonymously to reference any relevant vehicle platform, such as passenger vehicles, commercial vehicles, industrial vehicles, tracked vehicles, off-road and all-terrain vehicles, farm equipment, aircraft, spacecraft, etc. In an example, a motor vehicle includes a vehicle body with a passenger cabin, multiple road wheels attached to the vehicle body (e.g., via wheel corner modules coupled to a unibody or body-on-frame chassis), and other standard original equipment. A prime mover, which may be in the nature of an electric traction motor and/or an internal combustion engine (ICE) assembly, is located inside the vehicle body and drives the road wheel(s) to propel the vehicle. Also located inside the passenger cabin is a set of vehicle seats, each of which has a respective seat sensor, and an interior ambient lighting system, which includes a network of independently operable, multicolor lamp units.

Continuing with the discussion of the foregoing example, the vehicle is also equipped with a resident or remote vehicle controller that is programmed to communicate with the seat sensors to receive therefrom seat sensor data that identifies which of the vehicle seats, if any, are occupied. During vehicle operation, the controller communicates with one or more resident vehicle dynamics sensors to receive therefrom an alert that a vehicle trigger event was detected (e.g., front impact, rollover, weather-induced incident, medical-induced impairment, etc.). Upon detection of the trigger event, the controller responsively accesses resident or remote memory to retrieve therefrom an IAL map, which associates each multicolor lamp unit with a respective one of the vehicle seats. The controller then commands each multicolor lamp unit associated with an occupied vehicle seat to output a vehicle-calibrated visual cue in the form of a preset (first) color in a preset (first) pattern designed to denote one or more characteristics of that occupied vehicle seat. The occupied seat characteristic(s) denoted by the outputs of the multicolor lamp units may include seat occupied, seatbelt unlatched, occupant missing, and/or child occupant.

For any of the disclosed methods, CRM, and vehicles, the vehicle controller may evaluate the IAL map to identify one or more non-location-specific (NLS) lamp units of the IAL system that are not associated with a particular vehicle seat. Upon detection of a vehicle triggering event, the vehicle controller may command the NLS lamp unit(s) to output a preset (second) color in a preset (second) pattern designed to illuminate the passenger cabin. In this instance, the preset color and pattern of the occupied seat lamp units may be blinking amber, the preset color and pattern of the NLS lamp(s) may be steady white, and the NLS lamp(s) may be illuminated at the same time with the multicolor lamp units associated with the occupied vehicle seats. As another option, the multicolor lamp units associated with occupied vehicle seats may be commanded to output the preset (first) color and pattern at a preset (first) intensity and duty cycle.

For any of the disclosed methods, CRM, and vehicles, the vehicle controller may evaluate the seat sensor data to identify which of the vehicle seats, if any, are unoccupied. Upon detection of a vehicle triggering event, the vehicle controller may command each multicolor lamp unit associated with an unoccupied vehicle seat to output a preset (second) color in a preset (second) pattern designed to illuminate the passenger cabin. In this instance, the preset color and pattern of the occupied seat lamp units may be blinking amber, the preset color and pattern of the unoccupied seat lamp units may be steady white, and the unoccupied seat lamp units may be illuminated at the same time with the occupied seat lamp units. As another option, each multicolor lamp unit may be an independently operable, red-green-blue (RGB) light-emitting diode (LED) module that is mounted on or adjacent to its respective vehicle seat.

For any of the disclosed methods, CRM, and vehicles, the vehicle controller may communicate with multiple in-cabin seatbelt sensors to receive therefrom seatbelt sensor data that identifies which of the occupied vehicle seats, if any, have unlatched seatbelts. Upon detection of a vehicle triggering event, the vehicle controller may command each multicolor lamp unit associated with an occupied vehicle having an unlatched seatbelt to output a preset (third) color in a preset (third) pattern (e.g., designed to signify “occupied seat with unlatched belt”). In this instance, the preset color and pattern of the lamp units associated with occupied seats having latched belts may be slow blinking amber, the preset color and pattern of the lamp units associated with occupied seats having unlatched belts may be fast blinking red, and all multicolor lamp units may be illuminated at the same time with one another. The lamp units for occupied vehicle seats with latched seatbelts may be commanded to output the preset (first) color and pattern at a preset (first) intensity and duty cycle, whereas the lamp units for occupied vehicle seats with latched seatbelts may be commanded to output the preset (third) color and pattern at a different (third) intensity and duty cycle. As another option, the vehicle seat sensors may include one or more pressure sensors mounted within each vehicle seat (e.g., under or in a seat cushion), and the vehicle dynamics sensor may include an accelerometer, a gyroscope, an air pressure sensor, and/or an impact sensor mounted to the body of the motor vehicle.

For any of the disclosed methods, CRM, and vehicles, the vehicle controller may evaluate the seat sensor data to identify which of the vehicle seats, if any, are occupied by children. Upon detection of a vehicle triggering event, the vehicle controller may command each multicolor lamp unit associated with a vehicle seat occupied by a child to output a preset (fourth) color in a preset (fourth) pattern (e.g., designed to denote “seat with child occupant”). After detection of the vehicle trigger event, the vehicle controller may communicate with the seat sensors to receive therefrom new seat sensor data that identifies which of the occupied vehicle seats, if any, are now unoccupied. In this instance, the vehicle controller may command each multicolor lamp unit associated with a now-unoccupied vehicle seat to output a preset (fifth) color in a preset (fifth) pattern (e.g., fast blinking dark red to denote “occupied seat with missing occupant”).

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with an interior ambient lighting (IAL) system and a network of in-vehicle controllers, sensors, and communication devices for active occupant monitoring in accord with aspects of the present disclosure.

FIG. 2 is a flowchart illustrating a representative smart vehicle control protocol for occupant quantification and location using interior ambient lighting, which may correspond to non-transient, memory-stored instructions that are executable by a resident or remote processor, control module, programmable logic device, central controller, or other integrated circuit (IC) device or network of processors/controllers/modules/devices/etc. in accord with aspects of the present disclosure.

FIG. 3 is a plan-view illustration of a representative vehicle passenger cabin equipped with an interior ambient lighting system with which aspects of this disclosure may be practiced.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at or nearly at” or “same or nearly the same” or “within 0-5% of” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

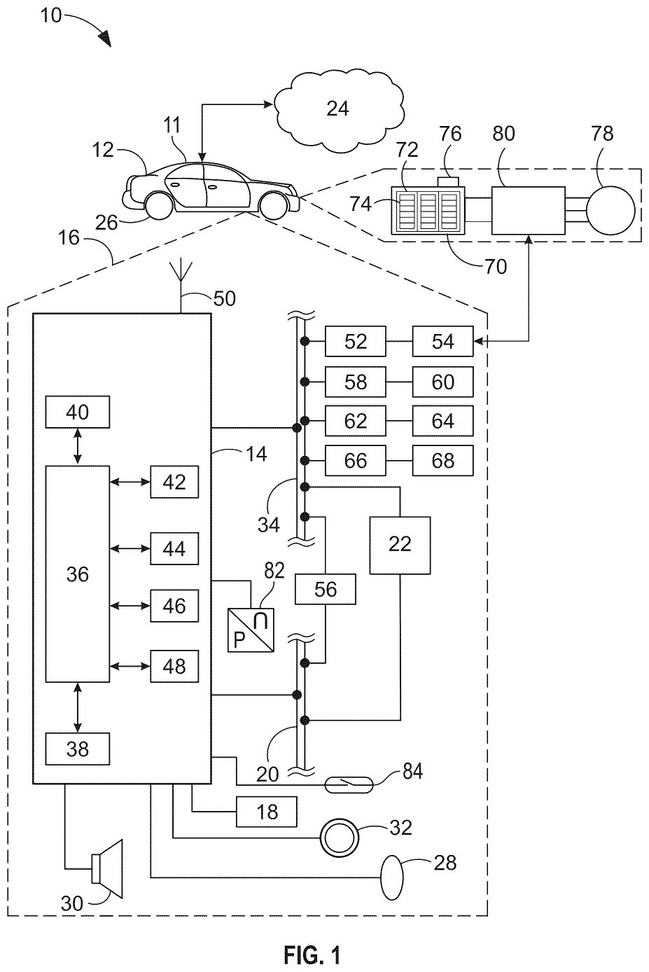

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which novel aspects of this disclosure may be practiced. In the same vein, incorporation of the present concepts into the specific interior ambient lighting system architecture presented in the drawings should also be appreciated as a non-limiting implementation of disclosed features. As such, it will be understood that novel aspects of this disclosure may be implemented by other lighting system architectures and may be incorporated into any logically relevant type of motor vehicle. Moreover, only select components of the motor vehicle and the IAL system are shown and described in detail herein. Nevertheless, the vehicles and IAL systems discussed below may include numerous additional and alternative features, and other available peripheral hardware, for carrying out the various methods and functions of this disclosure.

The representative vehicle 10 of FIG. 1 is originally equipped with a vehicle telecommunications and informatics (“telematics”) unit 14 that wirelessly communicates, e.g., via cellular network, satellite service, wireless-enabled modem, etc., with a remotely located cloud computing host service 24 (e.g., ONSTAR®). Some of the other vehicle hardware components 16 shown generally in FIG. 1 include, as non-limiting examples, an electronic video display device 18, a microphone 28, audio speaker(s) 30, and assorted user input controls 32 (e.g., buttons, knobs, dials, switches, touchpads, touchscreens, etc.). These hardware components 16 function, in part, as a human/machine interface (HMI) that enables a user to communicate with the telematics unit 14 and other components resident to and remote from the vehicle 10. Microphone 28, for instance, provides occupants with a means to input verbal commands; the vehicle 10 may be equipped with an embedded voice-processing unit with audio filtering, editing, and analysis modules. Conversely, the speaker 30 provides audible output to a vehicle occupant and may be either a stand-alone speaker dedicated to the telematics unit 14 or may be part of an in-cabin audio system 22. The audio system 22 is connected to a network connection interface 34 and an audio bus 20 to receive analog and digital signals, rendering it as sound, via one or more speaker components.

Communicatively coupled to the telematics unit 14 is a network connection interface 34, suitable examples of which include twisted pair/fiber optic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction and regenerative brake systems, controlling vehicle steering, and other automated functions. For instance, telematics unit 14 may exchange signals with a Powertrain Control Module (PCM) 52, an Advanced Driver Assistance System (ADAS) module 54, an Airbag Control Module (ACM) 56, a Body Control Module (BCM) 58, a Sensor System Interface Module (SSIM) 60, and assorted other vehicle ECUs, such as an Engine Control Module (ECM), a Motor Control Module (MCM), a Sensing and Diagnostics Module (SDM), a Brake System Control Module (BSCM), a Steering Control Module (SCM), etc.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, solid-state drive (SSD) memory, hard-disk drive (HDD) memory, phase-change memory, flash memory, semiconductor memory (e.g., various types of RAM or ROM), etc.

Long-range communication (LRC) capabilities with remote, off-board devices may be provided via one or more or all of a cellular chipset/component, a navigation and location chipset/component (e.g., global positioning system (GPS) transceiver), a wireless modem, or a mobile hotspot, all of which are collectively represented at 44. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual RF antenna 50. The communications devices described above may provision data exchanges as part of a periodic broadcast in a vehicle-to-vehicle (V2V) communication system or a vehicle-to-everything (V2X) communication system, e.g., Vehicle-to-Infrastructure (V2I), Vehicle-to-Pedestrian (V2P), Vehicle-to-Device (V2D), Vehicle-to-Cloud (V2C), etc.

CPU 36 receives sensor data from one or more sensing devices that use, for example, photo detection, radar, laser, ultrasonic, optical, infrared, or other suitable technology, including short range communications technologies (e.g., DSRC) or Ultra-Wide Band (UWB) radio technologies, for executing a controller-automated (AV/ADAS) driving operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automated vehicle operation.

To propel the automobile 10, a vehicle powertrain is operable to generate and deliver tractive torque to one or more of the vehicle's drive wheels 26. The powertrain is represented in FIG. 1 by an electric traction motor (M) 78 that is operatively connected to a rechargeable energy storage system (RESS), which may be in the nature of a chassis-mounted traction battery pack 70. The traction battery pack 70 is generally composed of one or more battery modules 72 each containing a cluster of battery cells 74, such as lithium-class, zinc-class, nickel-class, or organosilicon-class cells of the pouch, prismatic, or cylindrical type. One or more prime movers, such as traction motor/generator (M) units 78, draw electrical power from and, optionally, deliver electrical power to the battery pack 70. A power inverter module (PIM) 80 electrically connects the battery pack 70 to the motor(s) 78 and modulates the transfer of electrical current therebetween. The battery pack 70 may include an integrated electronics package, such as a wireless-enabled cell monitoring unit (CMU) 76, that enables on-module management, cell sensing, etc.

Presented below are smart vehicle systems with attendant control logic for employing interior ambient lighting systems to communicate occupant information to third party entities, such as real-time location and quantity of passengers to first responders after a vehicle impact, rollover, or immobilization event. Upon detection of any one of various predefined vehicle trigger events, for example, the interior ambient lighting (IAL) system leverages the in-cabin occupant sensor network to actively generate predefined visual cues that are designed to signify real-time information to aiding parties. Attendant benefits for at least some of the disclosed concepts may include enhanced occupant protection by alerting first responders to the number and position of vehicle passengers, as well as whether an occupant is a child or was wearing their seatbelt (occupant may have been ejected from cabin). By providing real-time passenger information to aiding parties, disclosed systems and methods may help to enhance protection of first responders by minimizing the amount of time they may spend in hazardous situations.

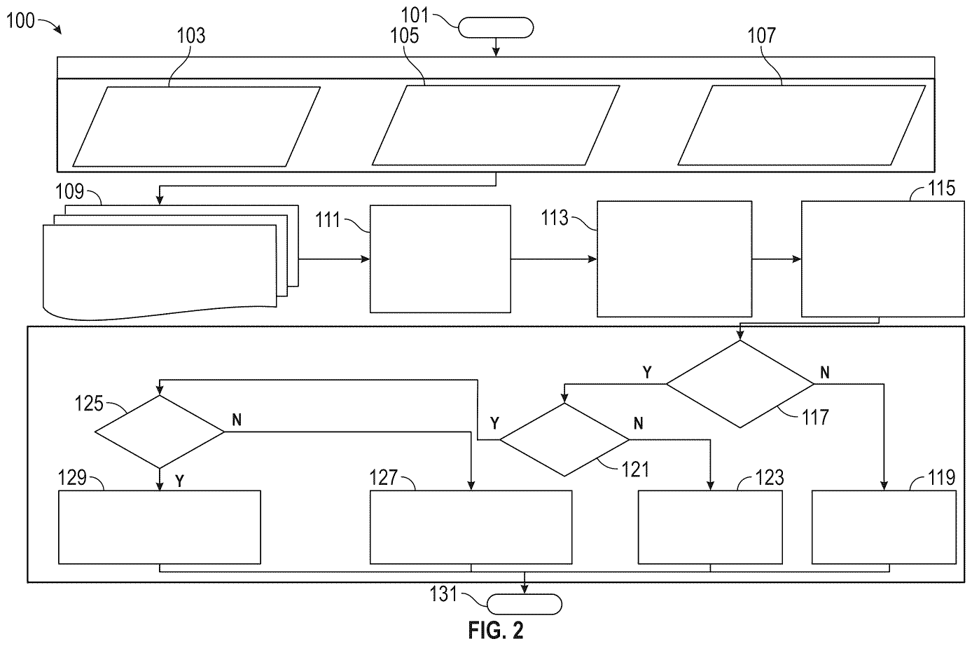

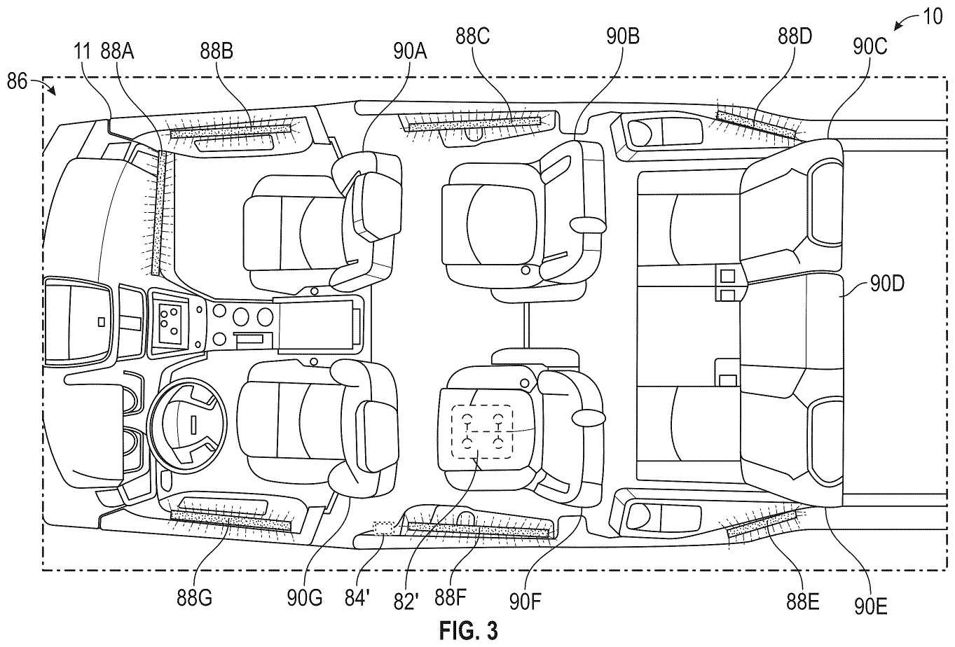

With reference next to the flowchart of FIG. 2, an improved method or control protocol for locating and quantifying occupants of a motor vehicle, such as automobile 10 of FIG. 1, using a vehicle lighting system, such as in-cabin IAL system 86 of FIG. 3, is generally described at 100 in accordance with aspects of the present disclosure. Some or all of the operations illustrated in FIG. 2 and described in detail below may be representative of an algorithm that corresponds to non-transitory, processor-executable instructions that may be stored, for example, in main or auxiliary or remote memory (e.g., resident vehicle memory 38 and/or remote cloud host service 24 database of FIG. 1). These instructions may be executed, for example, by a resident or remote microprocessor, central controller, dedicated control module, programmable logic device, or other module or device or network of processors/controllers/modules/devices (e.g., vehicle CPU 36 and/or server-class computer terminal of cloud host service 24 of FIG. 1) to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 100 may begin at START terminal block 101 of FIG. 2 with memory-stored, computer-readable instructions for initializing an occupant monitoring protocol for a motor vehicle. This routine may be initialized in real-time, near real-time, continuously, systematically, sporadically, and/or at predefined time intervals, for example, each 10 or 100 milliseconds during operation of the motor vehicle 10. As yet another option, terminal block 101 may initialize responsive to a user command prompt (e.g., via telematics input controls 32), a resident vehicle controller prompt (e.g., from CPU 36), or a broadcast prompt signal received from a centralized BO vehicle services system (e.g., from cloud host service 24). By way of non-limiting example, method 100 may automatically initialize during a key-on event in which a driver, owner, occupant, or other authorized operator of the vehicle 10 (collectively “user”) powers on the vehicle powertrain. Upon completion of some or all of the control operations presented in FIG. 2, method 100 may advance to END terminal block 131 and temporarily terminate or, optionally, may loop back to terminal block 101 and run in a continuous loop. Terminal block 131 may automatically trigger in response to a user shifting the powertrain into a neutral or park mode or in response to a key-off event in which a user powers off the host vehicle.

After initialization at terminal block 101, method 100 may require a vehicle controller link with an assortment of vehicle “enablers” that are employed by the integrated lighting control protocol to provision occupant monitoring services. At LIGHTING SYSTEM data input block 103, for example, the vehicle BCM 58 may communicate across network connection interface 34 with the resident IAL system 86, e.g., to confirm that the system 86 is available and its lamp units are functioning properly. IAL system 86 is represented in FIG. 3 by a network of independently operable, multicolor lamp units 88A, 88B, 88C, 88D, 88E, 88F and 88G that is located inside the passenger cabin 11 of the vehicle 10. The multicolor lamp units 88A-88G may take on an assortment of different form factors and lamp layouts, including independently operable, red-green-blue (RGB) light-emitting diode (LED) modules, each of which is mounted on or adjacent to a respective vehicle seat assembly 90A, 90B, 90C, 90D, 90E, 90F and 90G. Each vehicle seat may be associated with a single lamp unit, such as front driver seat 90G with a lone vehicle door-mounted lamp unit 88G, or may be associated with multiple light units, such as front passenger seat 90A with a dashboard-mounted lamp unit 88A and a vehicle door-mounted lamp unit 88B.

In addition to the in-vehicle lighting system, the vehicle BCM 58 may communicate with a resident network of seat occupancy sensors 82 and 82′, e.g., to confirm that the sensors 82, 82′ are available and functioning properly, as indicated at SEATING SYSTEM data input block 105. It is envisioned that the host vehicle's seat sensor system may utilize any suitable type and arrangement of occupancy sensors, including infrared, ultrasonic, binary electromechanical, and capacitive-type sensors that are mounted on or adjacent the vehicle seats. By way of non-limiting example, the host vehicle 10 may package a single fluidic-pressure seat sensor 82 underneath the seat cushion of each vehicle seat 90A-90F, as indicated in FIG. 1, or may package an array of piezoresistive force-sensitive resistor (FSR) seat sensors 82′ within the seat cushion of each vehicle seat 90A-90F, as shown in FIG. 3. Together with detecting seat occupancy, these seat sensors 82, 82′ may also be operable to measure occupant weight (e.g., to differentiate between children and adults) and track occupant position (e.g., to derive occupant location on the seat assembly).

When linking to the vehicle's lighting and occupancy systems, vehicle BCM 58 may also communicate with a resident network of seatbelt sensors 84 and 84′, e.g., to confirm that these sensors 84, 84′ are available and functioning properly, as indicated at SEATBELT SYSTEM data input block 107. The in-cabin seatbelt sensor system may be typified by a binary reed-switch type seatbelt sensor 84 that is packaged inside the individual buckle housings to sense latch engagement, as shown in FIG. 1. As another non-limiting option, the seatbelt sensor system may package a discrete load-cell type seatbelt sensor 84′ within the individual vehicle pillars to sense belt webbing tension. Other vehicle “enablers” used to provision the disclosed occupant monitoring services may include the body-mounted vehicle dynamics sensors 68, which may be in the nature of an inertial measurement unit (IMU) that contains a six-axis accelerometer and integrated gyroscope, a pressure sensor that measures large spikes in cabin air pressure, and/or a distributed array of impact sensors that each detects large force loads on the vehicle body 12. Host vehicle 10 may be equipped with additional or alternative sensing devices from that which are shown in the drawings and described above without departing from the intended scope and spirit of this disclosure.

Method 100 may advance from data input blocks 103, 105 and 107 to LIGHTING MAP document block 109 to retrieve a memory-stored interior ambient lighting map that maps each of the IAL system's multicolor lamp units with one of the vehicle seats or labels the multicolor lamp as a “non-location-specific” (NLS) lamp unit that is not assigned to a specific vehicle seat. During development of host vehicle 10 of FIG. 1, for example, all of the interior ambient lighting system lamps 88A-88G of FIG. 3 are assigned to a specific seat 90A-90G (e.g., lamp unit 88A, lamp unit 88B: front passenger seat 90A; lamp unit 88C: rear passenger seat 90B; lamp unit 88D: third-row passenger seat 90C, . . . ). Lamps not specifically assigned to one of the vehicle seats 90A-90G may be designated with an “NLS” marker or labelled as “unavailable” in system software. Some IAL system architectures may include lighting devices, such as a tricolor LED light strip or a multi-lamp dome light, that may be assigned to multiple vehicle seats. Conversely, some vehicle seats, such a center seat 90D or a collapsible third-row bench of passenger seats 90C-90E, may not be assigned a lamp unit.

In tandem with ascertaining lamp unit assignments, method 100 may execute SEAT STATUS database storage block 111 to begin collecting raw sensor data from the available vehicle “enablers” and then filter, preprocess, and store the preprocessed sensor data, e.g., in resident cache memory. For instance, the vehicle BCM 58 may communicate through the vehicle SSIM 60 with the seat occupancy sensors 82 and the seatbelt sensors 84 to derive real-time occupancy data, including total number of occupants, occupant-specific locations, and seat-specific seatbelt status. Method 100 may concomitantly execute OCCUPANT STATUS database storage block 113 to begin collecting raw sensor data from other available vehicle sensors and then filter, preprocess, and store this preprocessed data, e.g., in resident cache memory. By way of example, the vehicle BCM 58 may communicate through vehicle SSIM 60 with the ACM 56 and the seat occupancy sensors 82 to derive real-time passenger data, including passenger type (child or adult) and SIR deployment status.

With continuing reference to FIG. 2, method 100 may detect the advent of any one of several predefined triggering events that will concomitantly galvanize the vehicle's occupant quantification and location protocol, as indicated at TRIGGER EVENT process block 115. During operation of host vehicle 10 of FIG. 1, for example, one or more of the resident vehicle dynamics sensors 68 may communicate through SSIM 60 with the vehicle BCM 58 to transmit thereto sensor data that denotes a vehicle trigger event was detected (e.g., front impact, rollover, weather-induced incident, medical-induced impairment, etc.). Upon detection of a triggering event, the vehicle BCM 58 may responsively access cache memory of the resident vehicle memory devices 38 to aggregate the most up-to-date map data, occupancy data, and passenger data; this data is then passed to the ambient lighting system control logic. At a minimum, the BCM 58 may analyze the aggregated data to ascertain which of the vehicle seat assemblies 90A-90G are labelled as occupied and, of those designated occupied, which lamp unit is assigned to each seat and what is the seatbelt status for each seat. BCM 58 may also analyze available data to ascertain the passenger type, airbag status, and updated occupancy status for each seat.

Method 100 thereafter advances from process block 115 to LAMP STATUS decision block 117 to determine whether or not a particular lamp unit is assigned to a vehicle seat. Using the IAL map data retrieved at document block 109, for example, BCM 58 may evaluate each monochromatic lamp unit and each multicolor lamp unit 88A-88G within the vehicle's passenger cabin 11 to ascertain if that lamp is assigned to a particular vehicle seat assembly 90A-90G or is labelled as an NLS lamp. Responsive to a determination that an IAL system lamp unit is designated as “NLS” and, thus, is not mapped to a seat (Block 117=NO), method 100 may execute NLS ILLUMINATION process block 119 and command the NLS lamp unit to output a predefined (second) color in a predefined (second) pattern that is designed to illuminate the passenger cabin 11. In accord with the illustrated example, each NLS lamp unit may emit a steady white light at maximum available intensity.

After confirming that an IAL system lamp unit is mapped to a vehicle seat and, thus, is not designated as “NLS” (Block 117=YES), method 100 may respond by determining-at SEAT STATUS decision block 121 of FIG. 2—whether or not the vehicle seat to which that lamp unit is assigned is occupied. Continuing with the example presented in FIG. 1, the vehicle BCM 58 may evaluate the memory-stored, preprocessed sensor data output by seat occupancy sensors 82, 82′ to identify which of the vehicle seats 90A-90G are unoccupied. If the sensor data indicates that a vehicle seat was unoccupied prior to the trigger event (Block 121=NO), method 100 may respond by executing UNOCCUPIED ILLUMINATION process block 123 and command each IAL system lamp unit assigned to an unoccupied seat to output a predefined (second) color in a predefined (second) pattern that is designed to help illuminate the passenger cabin 11. In accord with the illustrated example, these lamp units may emit a steady white light at maximum available intensity. Alternatively, the lamp units for unoccupied seats may be turned off or may output a steady blue light to indicate this is an “unoccupied vehicle seat”.

SEAT STATUS decision block 121 may also determine whether or not a vehicle seat that was designated as occupied before a triggering event is now deemed to be unoccupied. Upon detection of a vehicle trigger event, as described above with respect to process block 115 of FIG. 2, BCM 58 may prompt the seat occupancy sensors 82, 82′ of each “occupied” vehicle seat for new seat sensor data. After filtering, preprocessing, and storing this new raw sensor data, the BCM 58 may evaluate the preprocessed data to identify which of the occupied vehicle seats are now unoccupied. After confirming that a pre-trigger-event occupied seat is now unoccupied post trigger event, the BCM 58 may automatically command each multicolor lamp unit associated with a now-unoccupied vehicle seat to output a predefined (fifth) color in a predefined (fifth) pattern. For at least some applications, these lamp units may be commanded at process block 123 to emit a fast blinking dark red color to alert first responders to an “occupied seat with missing occupant”.

Responsive to each determination that the vehicle seat to which a multicolor lamp unit is assigned is occupied (Block 121=YES), method 100 may execute SEATBELT STATUS decision block 125 to determine whether or not the seatbelt of that occupied vehicle seat is buckled. Vehicle BCM 58 of FIG. 1 may evaluate the memory-stored, preprocessed sensor data output by seatbelt sensors 84, 84′ to identify which of the vehicle seats designated as occupied have unlatched seatbelts. If the sensor data indicates that an occupied vehicle seat has an unlatched seatbelt (Block 125=NO), method 100 may respond by executing UNBUCKLED ILLUMINATION process block 127 and command each IAL system lamp unit assigned to an occupied seat with an unlatched belt to output a predefined (third) color in a predefined (third) pattern that is designed to warn third parties that this is an “occupied seat with unlatched belt”. In accord with the illustrated example, the IAL lamp units associated with occupied vehicle seats having unlatched seatbelts output a fast blinking red pattern. For instance, these lamps may flash a bright red color at the rate of the audible “click-clack” sound of the vehicle's hazard lights.

Upon confirming that the seatbelt of an occupied vehicle seat is latched (Block 125=YES), method 100 may respond by executing BUCKLED ILLUMINATION process block 129 and command each IAL system lamp unit assigned to an occupied seat with a latched belt to output a predefined (first) color in a predefined (first) pattern. By way of non-limiting example, these lamp units may be commanded to output a slow flashing amber light that is designed to alert third parties that this is an “occupied seat with latched belt”. SEAT STATUS decision block 121 and/or SEATBELT STATUS decision block 125 may also evaluate the available occupant data to identify which of the vehicle seats, if any, are occupied by children. BCM 58 may evaluate such factors as occupant location (e.g., back seat or third-row seat), occupant weight (e.g., less than 85 lbs), in-cabin camera data (e.g., facial recognition software) to detect and target child occupants. Upon detection of a child occupant, the BCM 58 may command each multicolor lamp unit 88A-88G assigned to a vehicle seat 90A-90G occupied by a child to output a preset (fourth) color in a preset (fourth) pattern (e.g., slow-blinking blue light that denotes this is a “seat with child occupant”).

It is envisioned that each of the lamp outputs described above may include a distinct preset color with a distinct color pattern this is output at a distinct intensity and/or a distinct duty cycle. Alternatively, the light outputs of the various lamp units may be coordinated to flash in unison with one another, e.g., at the same intensity and duty cycle, or may all be illuminated at the same time with a steady light output. In the same vein, it may be desired that the NLS lamps and the unoccupied seat lamps be illuminated at substantially the same time and with the same color and light intensity.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a motor vehicle with a vehicle controller and a passenger cabin containing multiple vehicle seats, the method comprising:
receiving, via the vehicle controller from multiple seat sensors located inside the passenger cabin, seat sensor data identifying the vehicle seats that are occupied vehicle seats;
receiving, via the vehicle controller from a vehicle dynamics sensor, dynamics sensor data indicating detection of a vehicle trigger event;
retrieving, via the vehicle controller responsive to detection of the vehicle trigger event, an interior ambient lighting (IAL) map for an IAL system with multiple multicolor lamp units located inside the passenger cabin, the IAL map associating each of the multicolor lamp units with a respective one of the occupied vehicle seats; and
commanding, via the vehicle controller using the IAL map, the multicolor lamp units associated with the occupied vehicle seats to output a first preset color in a first preset pattern configured to denote a characteristic of the occupied vehicle seat.

2. The method of claim 1, further comprising:
identifying, via the vehicle controller using the IAL map, a non-location-specific (NLS) lamp unit of the IAL system not associated with one of the vehicle seats; and
commanding, via the vehicle controller, the NLS lamp unit to output a second preset color in a second preset pattern configured to illuminate the passenger cabin.

3. The method of claim 2, wherein the first preset color is amber, the first preset pattern is blinking, the second preset color is white, the second preset pattern is steady, and the NLS lamp is illuminated together with the multicolor lamp units associated with the occupied vehicle seats.

4. The method of claim 1, further comprising:
determining, via the vehicle controller from the seat sensor data, the vehicle seats that are unoccupied vehicle seats; and
commanding, via the vehicle controller, the multicolor lamp units associated with the unoccupied vehicle seats to output a second preset color in a second preset pattern configured to illuminate the passenger cabin.

5. The method of claim 4, wherein the first preset color is amber, the first preset pattern is blinking, the second preset color is white, the second preset pattern is steady, and the multicolor lamp units associated with the unoccupied vehicle seats are illuminated together with the multicolor lamp units associated with the occupied vehicle seats.

6. The method of claim 1, further comprising:
receiving, via the vehicle controller from multiple seatbelt sensors, seatbelt sensor data identifying the occupied vehicle seats that have unlatched seatbelts; and
commanding, via the vehicle controller, the multicolor lamp units associated with the occupied vehicle seats having unlatched seatbelts to output a third preset color in a third preset pattern configured to denote occupied seat with unlatched belt.

7. The method of claim 6, wherein the first preset color is amber, the first preset pattern is blinking, the third preset color is red, the third preset pattern is blinking, and the multicolor lamp units associated with the occupied vehicle seats are illuminated together with the multicolor lamp units associated with the occupied vehicle seats having unlatched seatbelts.

8. The method of claim 1, further comprising:
determining, via the vehicle controller from the seat sensor data, the occupied vehicle seats that are occupied by children; and
commanding, via the vehicle controller, the multicolor lamp units associated with the occupied vehicle seats occupied by children to output a fourth preset color in a fourth preset pattern configured to denote seat with child occupant.

9. The method of claim 1, further comprising commanding, via the vehicle controller, the multicolor lamp units associated with the occupied vehicle seats to output the first preset color at a first preset intensity and the first preset pattern at a first duty cycle.

10. The method of claim 1, further comprising:
receiving, via the vehicle controller from the seat sensors responsive to detection of the vehicle trigger event, new seat sensor data identifying the occupied vehicle seats that are now unoccupied vehicle seats; and
commanding, via the vehicle controller, the multicolor lamp units associated with the now unoccupied vehicle seats to output a fifth preset color in a fifth preset pattern configured to denote occupied seat with missing occupant.

11. The method of claim 1, wherein each of the multicolor lamp units includes an independently operable red-green-blue (RGB) light-emitting diode (LED) module mounted on or adjacent the respective one of the occupied vehicle seats.

12. The method of claim 1, wherein the characteristic of the occupied vehicle seat denoted by the first preset color and the first preset pattern output by the multicolor lamp units includes seat occupied, seatbelt unlatched, occupant missing, and/or child occupant.

13. The method of claim 1, wherein the seat sensors identifying the occupied vehicle seats include one or more pressure sensors mounted within each of the vehicle seats, and wherein the vehicle dynamics sensor detecting the vehicle trigger event includes an accelerometer, a gyroscope, a pressure sensor, and/or an impact sensor mounted inside the motor vehicle.

14. A non-transient, computer-readable medium storing instructions executable by a vehicle controller of a motor vehicle with a passenger cabin containing multiple vehicle seats, the instructions, when executed, causing the vehicle controller to perform operations comprising:
receiving, from multiple seat sensors located inside the passenger cabin, seat sensor data identifying the vehicle seats that are occupied vehicle seats;
receiving, from a vehicle dynamics sensor, dynamics sensor data indicating detection of a vehicle trigger event;
retrieving, responsive to detection of the vehicle trigger event, an interior ambient lighting (IAL) map for an IAL system with multiple multicolor lamp units located inside the passenger cabin, the IAL map associating each of the multicolor lamp units with a respective one of the occupied vehicle seats; and
commanding the multicolor lamp units associated with the occupied vehicle seats to output a first preset color in a first preset pattern configured to denote a characteristic of the occupied vehicle seat.

15. A motor vehicle, comprising:
a vehicle body with a passenger cabin and a vehicle dynamics sensor;
a plurality of road wheels attached to the vehicle body;
a prime mover attached to the vehicle body and configured to drive at least one of the road wheels to thereby propel the motor vehicle;
a plurality of vehicle seats located inside the passenger cabin and each including a respective seat sensor;
an interior ambient lighting (IAL) system with a plurality of multicolor lamp units located inside the passenger cabin; and
a vehicle controller programmed to:
receive, from the seat sensors, seat sensor data identifying the vehicle seats that are occupied vehicle seats;
receive, from the vehicle dynamics sensor, dynamics sensor data indicating detection of a vehicle trigger event;
responsive to detection of the vehicle trigger event, retrieve an IAL map associating each of the multicolor lamp units with a respective one of the occupied vehicle seats; and
command the multicolor lamp units associated with the occupied vehicle seats to output a first preset color in a first preset pattern configured to denote a characteristic of the occupied vehicle seat.

16. The motor vehicle of claim 15, wherein the vehicle controller is further programmed to:
identify a non-location-specific (NLS) lamp unit of the IAL system not associated with one of the vehicle seats; and
command the NLS lamp unit to output a second preset color in a second preset pattern configured to illuminate the passenger cabin.

17. The motor vehicle of claim 15, wherein the vehicle controller is further programmed to:
determine, from the seat sensor data, the vehicle seats that are unoccupied vehicle seats; and
command the multicolor lamp units associated with the unoccupied vehicle seats to output a second preset color in a second preset pattern configured to illuminate the passenger cabin.

18. The motor vehicle of claim 15, wherein the vehicle controller is further programmed to:
receive, from multiple seatbelt sensors, seatbelt sensor data identifying the occupied vehicle seats that have unlatched seatbelts; and
command the multicolor lamp units associated with the occupied vehicle seats having unlatched seatbelts to output a third preset color in a third preset pattern configured to denote occupied seat with unlatched belt.

19. The motor vehicle of claim 15, wherein the vehicle controller is further programmed to:
determine, from the seat sensor data, the occupied vehicle seats that are occupied by children; and
command the multicolor lamp units associated with the occupied vehicle seats occupied by children to output a fourth preset color in a fourth preset pattern configured to denote occupied seat with child occupant.

20. The motor vehicle of claim 15, wherein the vehicle controller is further programmed to:
receive, from the seat sensors responsive to detection of the vehicle trigger event, new seat sensor data identifying the occupied vehicle seats that are now unoccupied vehicle seats; and
command the multicolor lamp units associated with the now unoccupied vehicle seats to output a fifth preset color in a fifth preset pattern configured to denote occupied seat with missing occupant.
